(19) United States
(12) Patent Application Publication
(10) Pub. No.: US 2010/0196768 A1
(43) Pub. Date: Aug. 5, 2010

(54) ELECTROLYTE MANAGEMENT IN ZINC/AIR SYSTEMS

(76) Inventors: Gregory Roberts, Oakland, CA (US); Irfan Rehmanji, Vancouver (CA)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/451,167

(22) PCT Filed: Apr. 25, 2008
(86) PCT No.: PCT/US08/05334

§ 371 Date: Mar. 30, 2010

Related U.S. Application Data
(60) Provisional application No. 60/926,618, filed on Apr. 27, 2007.

(51) Int. Cl. H01M 8/22

(52) U.S. Cl. 429/406

(57) ABSTRACT

A zinc/air system such as a fuel cell or mechanically rechargeable zinc/air battery has a zincate-trapping material to extend electrolyte life. Solid calcium hydroxide is used as the zincate-trapping material in some embodiments. The zincate-trapping material may be provided in the form of pellets, powders, or the like in assemblies that permit electrolyte to contact the zincate-trapping material. The assemblies may be replaceable while the system remains in operation. In some embodiments, the assemblies are removable and may be processed after use to collect zinc for recycling.

### REFERENCE TO RELATED APPLICATION

This application claims priority from U.S. patent application No. 60/926,618 filed on 27 Apr. 2007 and entitled ELECTROLYTE REMEDIATION IN ZINC-AIR FUEL CELLS. For purposes of the United States of America, this application claims the benefit under 35 U.S.C. §119 of U.S. patent application No. 60/926,618 filed on 27 Apr. 2007, which is hereby incorporated herein by reference.

### TECHNICAL FIELD

This invention relates to electrochemical cells. The invention has particular application to zinc/air-based fuel cells and mechanically rechargeable batteries with circulating electrolytes.

### BACKGROUND

Electrochemical zinc/air cells have zinc-based negative electrodes, referred to as anodes in primary cells, and gas-diffusion positive electrodes, referred to as cathodes in primary cells. Such cells electro-catalytically reduce oxygen from air. The electrolyte is typically a concentrated solution of potassium hydroxide (KOH) or sodium hydroxide (NaOH) in liquid or gel form.

Zinc/air batteries and fuel cells are commercially appealing for several reasons. Zinc is an attractive anode material because it is abundant, has a low equivalent weight, has a low standard reduction potential in the electrochemical series, and is environmentally favorable compared to alternatives like cadmium. A zinc/air battery or fuel cell can have a relatively small weight and volume because a reactant, oxygen, can be obtained from atmospheric air instead of being stored for use.

Zinc/air fuel cells and mechanically rechargeable batteries can be replenished by adding zinc and by either replacing the electrolyte, which accumulates reaction products during cell operation, or by removing dissolved reaction products from the electrolyte.

In a zinc/air cell, the anodic reaction is commonly written as:

Zn+4OH⁻→Zn(OH)₄²⁻+2e⁻ (1)

In concentrated alkaline electrolytes, the tetrahydroxozincate ion (Zn(OH)₄²) is highly soluble. It is commonly referred to as the zincate ion. Zinc oxide can precipitate by the following reaction:

Zn(OH)₄²⁻→ZnO+H₂O+2OH (2)

The cathodic reaction is given by:

½O₂+H₂O+2e⁻→2OH⁻ (3)

Anodically dissolved zinc can form supersaturated solutions with concentrations well beyond the equilibrium concentration in alkaline solutions (see e.g., F. R. McLarnon and E. J. Cairns, The Secondary Alkaline Zinc Electrode, Journal of the Electrochemical Society, Vol. 138, Issue 2, p. 645). Electrolyte additives, such as silicate salts, can be used to stabilize the supersaturated solutions and retard zinc oxide precipitation. Details about the differences between supersaturated and undersaturated zincate solutions in alkaline electrolytes are described in C. Debiemme-Chouvy, J. Vedel, M. Bellissent-Funel, and R. Cortes, Supersaturated Zincate Solutions: A Structural Study, Journal of the Electrochemical Society, Vol. 142, No. 5, May 1995, p. 1359.

The high solubility of the zincate ion in alkaline solutions causes longevity and reliability problems in secondary zinc/air batteries. The issues of zinc dendrite formation, which can cause cell shorting, and anode shape change due to preferred locations for the deposition of zinc, are well known in the field. One attempted solution is to use a solid-phase material that can remove tetrahydroxozincate ions from solution by chemical reaction. Calcium hydroxide is often preferred as the material for scavenging zincate ions. Calcium hydroxide can react with the soluble zincate ion to form calcium zincate, a solid phase with low solubility in alkaline electrolytes, by the following reaction:

Ca(OH)₂+2Zn(OH)₄²⁻+2H₂O→Ca(OH)₂.2Zn(OH)₂.2H₂O+4OH⁻ (4)

The solid phase is also referred to as a zincate, and it is common practice to refer to the solid phase by its full name (e.g., ‘calcium zincate’ or ‘magnesium zincate from reaction with magnesium hydroxide’) to avoid confusion with the soluble zincate ion.

Calcium hydroxide powder is often incorporated directly into the negative electrode along with zinc, binders, and other materials. U.S. Pat. No. 4,358,517 discusses using a certain ratio of calcium hydroxide to zinc active material for a nickel/zinc secondary battery for this purpose. U.S. Pat. No. 5,863,676 advocates using calcium zincate, the material formed by the reaction of zincate ions with calcium hydroxide, directly as the active material in a secondary battery. U.S. Pat. Nos. 3,873,367 and 3,516,862 describe using calcium hydroxide for these purposes in sealed, electrically-rechargeable cells. U.S. Pat. Nos. 3,516,862; 2,180,955; 3,497,391; and 3,873,367 discuss integrating calcium hydroxide in sealed zinc batteries. U.S. Pat. No. 3,873,367 discusses the use of magnesium hydroxide in addition to calcium hydroxide. U.S. Pat. No. 4,054,725 discusses using calcium hydroxide within a zinc/air battery to remove carbonate ions introduced as carbon dioxide from unscrubbed air is fed through the air cathode and dissolved into the electrolyte.

Zinc/air fuel cells and mechanically rechargeable batteries have electrolyte-related challenges. If the zinc and air reactants can be supplied continuously to a fuel cell, the only limitation in operating time will be the degradation of electrolyte performance as reaction products accumulate in the electrolyte. The reaction that generates zincate ions from anodically dissolved zinc consumes hydroxide ions, which adversely impacts fuel cell performance by lowering the ionic conductivity of the electrolyte and increasing concentration polarization. If the cell conditions and electrolyte chemistry allow for zinc oxide precipitation, the precipitation reaction will release hydroxide ions but may cause other problems. Precipitated zinc oxide can lower electrical conductivity by coating metallic particles and current collectors, clogging pores in electrodes and separators, and affecting components in systems with circulating electrolytes. The electrolyte will eventually need to be replaced or regenerated because of the accumulation of reaction products. The electrolyte can be regenerated by plating dissolved zinc, but this is not possible or desirable for all systems and applications.

Despite the work that has been done in this field, there remains a need for practical ways to extend the useful electrolyte life and/or improve the performance characteristics of zinc/air fuel cells and mechanically rechargeable batteries.

### SUMMARY

The present invention has a number of aspect. One aspect of the invention provides zinc/air systems such as primary batteries, fuel cells, and/or mechanically rechargeable batteries that use continuously or intermittently circulating alkaline solutions as an electrolyte. Other aspects of the invention relate to methods for operating and/or methods for maintaining zinc/air primary batteries, fuel cells, and/or mechanically rechargeable batteries.

An example aspect of the invention provides a method for operating a zinc/air system. The system comprises a first zinc-containing electrode; a second gas-diffusion electrode; and an alkaline electrolyte. The method comprises circulating the electrolyte and allowing the circulating electrolyte to contact a zincate-trapping material at a location apart from the first electrode.

Another example aspect of the invention provides a zinc/air electrochemical system. The system comprises a first zinc-containing electrode; a second gas-diffusion electrode; an alkaline electrolyte; and, a zincate-trapping material in contact with the alkaline electrolyte and spaced apart from the first electrode. The system may be, for example, a fuel cell, a primary or secondary battery or the like.

Another example aspect provides an assembly for use in remediating an alkaline electrolyte in a zinc/air electrochemical system. The assembly comprises a zincate-trapping material contained within an electrolyte-permeable enclosure.

Certain embodiments provide methods for the entrapment of dissolved zincate ions into a solid phase. In some embodiments, zincate-trapping material is external to the anode. In some embodiments the zincate-trapping material is outside of the electrochemical cell area. In some embodiments spent zincate-trapping material may be removed and replaced with new trapping zincate-material.

In addition to the exemplary aspects and embodiments described above, further aspects and embodiments will become apparent by reference to the drawings and by study of the following description and claims.

### BRIEF DESCRIPTION OF THE DRAWINGS

The attached drawings illustrate non-limiting example embodiments of the invention.

FIG. 1 is a block diagram of a prior-art zinc/air fuel cell.

FIG. 2 is a block diagram of a zinc/air fuel cell according to an example embodiment of the invention.

FIG. 2A is a partial schematic drawing illustrating a replaceable cartridge holding a zincate-trapping material.

FIG. 3 is a block diagram of a fuel cell system according to another embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Example embodiments of the invention provide ways to remove zincate ions from the electrolyte in zinc/air fuel cells and mechanically rechargeable batteries that use circulating alkaline electrolytes. This description describes example zincate-trapping materials (which may be called ‘zincate scavengers’), example physical forms for the trapping materials, example zinc/air systems and example methods to incorporate zincate-trapping materials in zinc/air systems having circulating electrolytes.

### Zincate-Trapping Materials

Calcium hydroxide is a suitable material to address electrolyte longevity and performance problems related to electrolyte conductivity, density, concentration polarization of the electrodes, and zinc oxide precipitation in zinc/air fuel cells and mechanically rechargeable batteries. Full or partial removal of zincate ions, which are produced by the anodic dissolution of the zinc anode, can increase the electrolyte conductivity, lower the electrolyte density, and reduce electrode polarization. Further, if desired to operate the fuel cell or battery without zinc oxide precipitation and with or without precipitation-inhibiting electrolyte additives, the removal of zincate ions by the scavenging material can keep the zincate concentration below the threshold for zinc oxide precipitation. Hydroxides and oxides of other alkali earth metals, such as magnesium hydroxide and barium hydroxide, may also be used as zincate-trapping materials. A zincate-trapping material may also be provided in the form of an oxide of calcium or another suitable alkali earth metal. Calcium oxide, for example, undergoes spontaneous hydration in water to form the calcium hydroxide.

The zincate-trapping material comprises calcium in some embodiments. In some embodiments the material comprises one or more of:
calcium hydroxide;
barium hydroxide;
strontium hydroxide; and
combinations thereof.
   The material is provided in the form of pellets or a powder in some embodiments.

Calcium hydroxide is a suitable material for scavenging zincate and has a number of desirable characteristics which may include:
By volume and mass, calcium hydroxide is an efficient material for removing zincate ions from solution. Two moles of zincate ions can react with each mole of calcium hydroxide, as shown by reaction (4) above, in which the reaction product is known as calcium zincate.
Calcium hydroxide is only sparingly soluble in concentrated alkaline solutions.
The reaction product, calcium zincate, is only sparingly soluble in concentrated alkaline solutions.
The reaction is reversible, so zinc can be recovered by removing zincate ions from the calcium zincate.

As a demonstration that calcium hydroxide is effective for removing zincate ions from electrolytes used zinc/air fuel cells, calcium hydroxide powder with a mean particle size of approximately 2 microns was added to an exhausted electrolyte from a zinc/air fuel cell and agitated. The electrolyte capacity was approximately 100 Ah/L with an originally 30 wt % KOH electrolyte. Subsequently, solids were collected by filtering the electrolyte after 2 days at room temperature. A sample of the collected material was analyzed by x-ray diffraction. The analysis confirmed that the material was primarily calcium zincate. All diffraction lines greater than 2% relative intensity were indexed to calcium zincate, indicating that the calcium hydroxide conversion to calcium zincate was nearly total. No significant amounts of calcium hydroxide, zinc hydroxide, or zinc oxide were detected in the collected material.

More details about the properties and reactions of calcium hydroxide in zincate-containing alkaline electrolytes are described in the references Y. Wang and G. Wainwright, Formation and Decomposition Kinetic Studies of Calcium Zincate in 20 w/o KOH, Journal of the Electrochemical Society, Vol. 133, No. 9, p. 1869, September 1986, and R. A. Sharma, Physico-Chemical Properties of Calcium Zincate, Journal of the Electrochemical Society, Vol. 133, No. 11, p. 2215, November 1986.

### Appropriate Physical Forms for Zincate-Trapping Materials

The physical form of the zincate-trapping material can facilitate efficient removal of zincate ions from the electrolyte. Ideally, all of the provided zincate-trapping material (calcium hydroxide for example) is available to be converted to an insoluble zincate-containing reaction product (calcium zincate for example). The availability of zincate-trapping material to trap zincate can be enhanced by providing the zincate-trapping material in a form that provides a relatively high surface area to volume ratio and which discourages the zincate-trapping material from consolidating, packing, or “cementing” in a manner which blocks access by electrolyte to some of the zincate-trapping material.

Where zincate-trapping material is provided in the form of large particles then it is possible that the only that portion of the zincate-trapping material in an outer shell of the particles may be available to trap zincate from an electrolyte. Zincate-trapping material in interior parts of the particles may be shielded from contact with the electrolyte by the surrounding outer shell. Also, it has been reported that calcium hydroxide particles can be passivated by a layer of calcium carbonate, which may be formed by a reaction of calcium hydroxide with carbonate ions. Finally, testing with an unagitated mass of settled particles has shown that the layer of particles in contact with the electrolyte can develop a skinned-over layer of reaction product that prevents good electrolyte circulation and contact with particles underneath the layer of reaction product.

In a flowing electrolyte system the zincate-trapping material may be physically isolated from the zinc electrode and may even be outside of an electrolyte circulation path of the operating zinc/air system.

Approaches for incorporating zincate-trapping material in a system such as a cell or stack having a flowing electrolyte include providing the zincate-trapping material in the form of a loose powder and confining the powder in a desired volume within the system. The loose powder may be agitated to promote electrolyte contact and to prevent cementation. A permeable barrier may be provided to keep a powder or other particles confined to a particular location in a system. The permeable barrier may comprise, for example, a porous polypropylene mesh, an electrolyte-permeable membrane, a sack, an apertured plate, a suitable filter material or the like.

Another approach involves providing a zincate-trapping material in an engineered form in which the zincate-trapping material is fixed.

In the embodiments that follow, calcium hydroxide is described as the zincate-ion trapping material, but any other suitable zincate-trapping material or materials could also be used.

Non-limiting example embodiments which provide zincate-trapping materials in the form of loose particles, such as powders include the following:
Providing a zincate-trapping material in a stirred reactor tank in which calcium hydroxide particles are prevented from settling and ensured of adequate contact with the electrolyte by agitation within the tank. The tank may be in any suitable location to which electrolyte can be brought. The tank may be outside of the electrochemical cell area. Suitable permeable barriers may be provided to keep the particles from leaving the tank.
Providing a fluidized-bed reactor in which forced convection of the electrolyte suspends calcium hydroxide particles. The fluidized-bed reactor may be outside of the electrochemical cell area. Suitable permeable barriers may be provided to keep the particles from leaving the fluidized-bed reactor.
Providing a flow-through filter assembly (for example a filter bag) containing calcium hydroxide particles. The filter assembly could be placed outside the electrochemical cell area or inside the electrochemical cell area. The filter assembly could be but is preferably not located directly between the anode and cathode of a cell.
Providing a mechanism to feed or drop particles into an electrolyte settling tank, with a particle settling time large enough for the particles to be substantially reacted in the electrolyte before reaching the bottom of the tank. Suitable permeable barriers may be provided to keep the particles from leaving the tank, if necessary. Methods according to some embodiments involve feeding or dropping particles into an electrolyte settling tank with or without the use of a mechanism specifically adapted for this purpose.
   Any of the foregoing embodiments could be operated continuously, intermittently, or with multiple reactor areas staged together.

Non-limiting example embodiments which involve engineered forms of zincate-trapping material include the following:
Compressed pellets of calcium hydroxide with water and hydroxides from the alkali metal elements, such as soda lime pellets.
Compressed pellets of calcium hydroxide with a binder with or without an expander material to enhance contact with the electrolyte, such as calcium hydroxide with a swelling material like cellulose as an expander with a binder like PTFE.
Beads, foams or other suitable substrate supporting calcium hydroxide particles immobilized by a suitable binder. For example, calcium hydroxide immobilized on polypropylene beads with a PTFE binder.
Porous mats, meshes, filter bags, membranes or the like supporting immobilized particles of calcium hydroxide or containing calcium hydroxide particles. An example embodiment may be made by soaking a bag in an aqueous solution of calcium hydroxide and then drying the bag in the absence of carbon dioxide. In another example embodiment, particles of calcium hydroxide are precipitated inside a bag by dipping the bag into an alkaline solution with lower calcium hydroxide solubility.
Providing a thin sheet comprising calcium hydroxide with a binder and with or without a swellable material, such as calcium hydroxide particles bound together with a PTFE binder and swellable cellulose fibers. In some embodiments the sheet has a thickness in a range of about 1/32″ thick to about ⅜″. The sheet may be formed by compressing a powdered zincate-trapping material with the binder and swellable material, if present.
Casting and drying a slurry of calcium hydroxide particles with a binder and with or without a swellable material on one or both sides of a sheet of material that is inert in the electrolyte, such as a slurry of calcium hydroxide with cellulose and PTFE cast onto nickel sheet, polypropylene sheet, alkaline-stable cermet sheet or FR-4 board.
   Such engineered materials may be placed at locations where they will be exposed to electrolyte in a zinc-air system.
   Incorporation of Zincate-Trapping Materials in Systems with Flowing Electrolyte

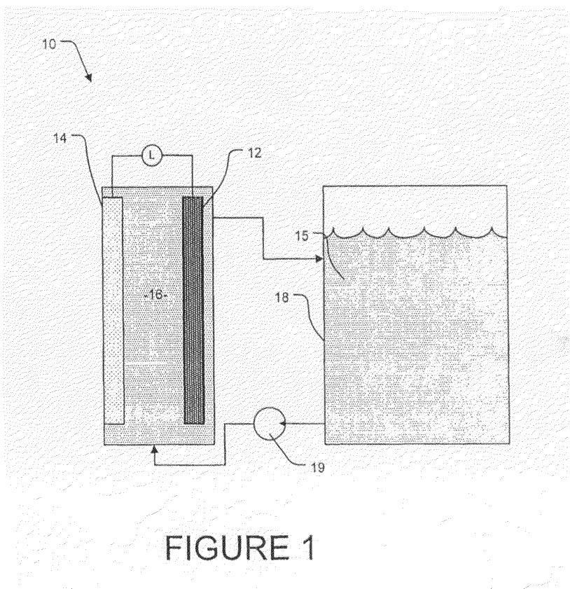

FIG. 1 shows a prior art zinc/air fuel cell 10. Fuel cell 10 has a zinc anode 12 separated from a gas-diffusion electrode 14 by a space 16. Zinc anode 12 may comprise a slurry or paste containing zinc metal or zinc pellets disposed in a packed bed or other suitable arrangement, for example. Gas-diffusion electrode 14 is in contact with air and typically contains a catalyst for promoting a reaction of oxygen from the air with an electrolyte of the fuel cell to form hydroxide ions.

An electrolyte 15, such as an aqueous potassium hydroxide solution, is present in space 16 between gas-diffusion electrode 14 and zinc anode 12. Electrolyte 15 is in contact with gas-diffusion electrode 14 and zinc anode 12. Electrolyte 15 is circulated from an electrolyte reservoir 18 through space 16 and back to reservoir 18 by circulation pump 19.

Fuel cell 10 has a potential difference between zinc anode 12 and gas-diffusion electrode 14. The potential difference can drive an electrical current through an external circuit including a load L. As fuel cell 10 operates, zinc metal from zinc anode 12 becomes dissolved in electrolyte 15. The dissolution of zinc into electrolyte 15 causes the composition and properties of electrolyte 15 to change. These changes affect the performance of fuel cell 10.

The zinc loading in the electrolyte can be represented as an electrolyte capacity. The electrolyte capacity may be defined in units of Ah/L. As the electrolyte capacity increases, the voltage produced by the fuel cell decreases when operating at a fixed current. At some point, the performance of the fuel cell will degrade to the point that the electrolyte will need to be replaced. The maximum electrolyte capacity before the electrolyte is considered exhausted depends on the electrolyte composition, fuel cell operating conditions, and the maximum acceptable decrease in performance. As an example, a 45 wt % potassium hydroxide electrolyte may need to be changed at 200 Ah/L for the fuel cell to continue delivering power exceeding the minimum acceptable power.

Zincate ions produced by the anodic dissolution of zinc metal may precipitate out of the solution in the form of zinc oxide. Such precipitation can cause various problems, including the following:
Obstruction of the pores of the gas-diffusion electrode assembly 14;
Accumulation of zinc oxide in the zinc anode 12, including coating zinc particles and the anodic current collector in insulating zinc oxide; and/or
Accumulation of zinc oxide in flow channels, pumps, or valves.
   Additionally, zinc oxide precipitate that is dispersed throughout the system cannot be effectively collected so that it can be recycled.

If sufficient zinc is provided at zinc anode 12, the run-time of the fuel cell 10 is limited by the volume of electrolyte 15. The run time may be extended by increasing the volume of electrolyte 15, but this increases the weight and volume of fuel cell 10.

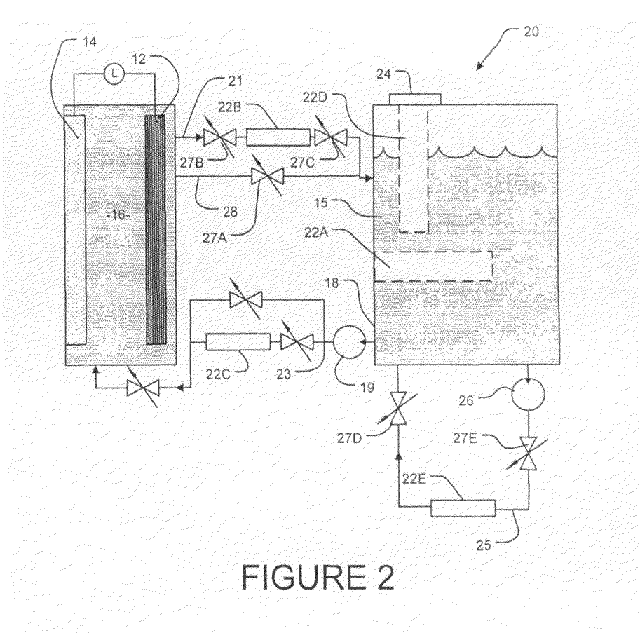

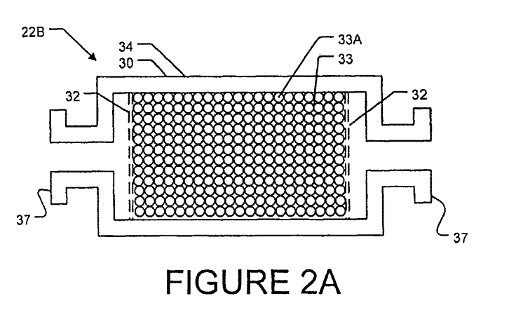

FIG. 2 shows a fuel cell system 20, which is similar to system 10 of FIG. 1 except that it comprises zincate-trapping assemblies 22A through 22E (collectively assemblies 22). Components present in both FIGS. 1 and 2 are identified by the same reference numerals. Assemblies 22A through 22E would typically not all be provided. They have been shown in FIG. 2 to illustrate a variety of placement options for zincate-trapping assemblies in a zinc/air fuel cell. In some embodiments the zinc-trapping assemblies are located outside of the electrochemical cell area (i.e., not co-located with the two electrodes or in the electrolyte directly between the two electrodes). In some embodiments the electrodes are in a vessel and the zinc-trapping assemblies are located outside of the vessel containing the electrodes.

System 20 may comprise a fuel cell or battery arranged in any suitable manner. In some non-limiting example embodiments, the fuel cell or battery has:
a configuration with bipolar plates.
a bicell configuration.
a configuration providing a plurality of individual electrochemical cells.

Some ways to incorporate a zincate-trapping material such as calcium hydroxide in a zinc/air system include:
The zincate-trapping material may be provided in a removable and replaceable assembly within the fuel cell system.
The zincate-trapping material may be provided in a removable and replaceable assembly associated with (e.g. located inside or attached to the body of) an electrolyte reservoir.
The zincate-trapping material may be provided as a separate component added onto a zinc/air system.
The zincate-trapping material may be provided as a non-replaceable component in an electrolyte reservoir (where the electrolyte reservoir is intended to be used only once before it is recycled).
The zincate-trapping material may be provided as an in situ component (i.e. a component that is not designed to be removed or replaced in normal use) of the fuel cell in situations where the fuel cell is intended for one time use (before recycling or remanufacturing).

Assembly 22A is provided within electrolyte reservoir 18. Assembly 22B is provided in-line in an inlet line 21 to deliver electrolyte 15 to reservoir 18. Assembly 22C is provided in-line in an outlet line 23 that delivers electrolyte 15 from reservoir 18. Assembly 22D is disposed in a cap 24 that closes an opening into electrolyte 18. Assembly 22E is disposed in a loop 25 through which electrolyte is pumped by pump 26. It can be appreciated that, in a range of embodiments of the invention, the assembly 22 that removes zincate from the electrolyte 15 is disposed in a location such that the main flow of electrolyte to and from the assembly in which zinc anode 12 is located is not required to pass through assembly 22.

FIG. 2A shows an assembly 22B. Assembly 22B, like other assemblies 22, comprises a container 30 that has at least one permeable wall portion 32 through which electrolyte 15 can enter container 30. A suitable zincate-trapping material 33, such as calcium hydroxide, is contained within container 30. In the illustrated embodiment, assembly 22B has the form of a tubular section 34 containing zincate-trapping material 33 in a form that is immobilized such that it does not leave section 34. For example, the zincate-trapping material may be provided in the form of pellets 33A, as shown, or in the form of a powder or other particles captured by, embedded in, adherent to, or otherwise held by a suitable matrix such as plastic beads, a permeable membrane, a sheet, a mesh, a filter medium, or the like. Some of these forms of scavenging material, such as sheets, powder immobilized on beads or foils, etc.) would not require permeable wall 32 to allow electrolyte flow while retaining the scavenging material.

Embodiments in which the scavenging material is provided in the form of a loose powder or other loose particles may include hardware, such as a mechanical stirrer, to agitate the powder and prevent settling. In some embodiments, a mechanical stirrer or agitator is actuated by a flow of electrolyte. In some embodiments which include a mechanical stirrer or agitator the mechanical stirrer or agitator is driven by a motor, actuator or the like.

In the illustrated embodiment, wall portions 32 are provided by perforated walls (for example, screens, perforated plates, or the like) at each end of assembly 22B. The wall portions constitute electrolyte-permeable barriers and keep pellets 33A inside section 34. Fluid-tight connectors 37 are provided to connect assembly 22B in-line carrying a flow of electrolyte 15.

Electrolyte 15 can flow through section 34 and, in doing so, contacts pellets 33A. Pellets 33A react with zincate from electrolyte 15. Where pellets 33A comprise pellets of calcium hydroxide, over time, pellets 33A become partially or entirely converted to calcium zincate. Assemblies 22 are designed to accommodate any increase in volume as the zincate-trapping material reacts with zincate ions in electrolyte 15.

Assemblies 22 may be field-replaceable. In fuel cell system 20 of FIG. 2:
Assembly 22B may be replaced while fuel cell system 20 is in operation by opening valve 27A to allow electrolyte 15 to flow through bypass line 28 and closing valves 27B and 27C to isolate assembly 22B. The couplings that connect assembly 22B into inlet line 21 can then be disconnected and assembly 22B can be replaced. Valves 27B and 27C can then be opened and valve 27A can be closed to place the replacement assembly 22B into service.
Assembly 22C may be removed and replaced according to a procedure that is essentially the same as the procedure for removing and replacing assembly 22B.
Assembly 22D may be replaced while fuel cell system 20 is in operation by removing and replacing cap 24.
Assembly 22E may be replaced by turning off pump 26, closing valves 27D and 27E, disconnecting the couplings that connect assembly 22E into loop 25, connecting a replacement assembly 22E in loop 25, opening valves 27D and 27E and restarting pump 26. This may be done while fuel cell system 20 is in operation.

The following example demonstrates the effectiveness of using a zincate-trapping material in a zinc/air fuel cell having a configuration similar that shown in FIG. 2. A zinc/air fuel cell was operated with a 30 wt % KOH-based electrolyte until the electrolyte could no longer sustain operation at a current density of 140 mA/cm², corresponding to an electrolyte capacity of 148 Ah/L. Next, the electrolyte was exposed to agitated calcium hydroxide powder. The calcium hydroxide and reacted calcium zincate were separated from the electrolyte with a porous polypropylene bag filter, similar to assembly 22E in FIG. 2. The conductivity of the electrolyte at 20° C. increased 36%, from 202 mS/cm to 275 mS/cm. With the filtered electrolyte, the cell was able to run at the same operating conditions for an additional 36 Ah/L, which represents a 24% improvement in the electrolyte utilization. For comparison, a reference cell that was treated identically with the exception that the electrolyte was not exposed to calcium hydroxide, was only able to run for an additional 3 Ah/L after the electrolyte was allowed to stand for the same duration as the electrolyte that was treated by exposure to calcium hydroxide.

The principles discussed herein can be applied to make significant reductions in electrolyte volume and mass for a system providing a desired level of performance. For example, assume an electrolyte comprising 45 wt % KOH reached its useful capacity limit at 200 Ah/L (note that this limit is just an example because practical limits are affected by the zinc/air system design and the operating conditions). Based on mass, fully utilized calcium hydroxide is 10.3 times more efficient at trapping an equivalent amount of zincate than 45 wt % KOH at a capacity of 200 Ah/L.

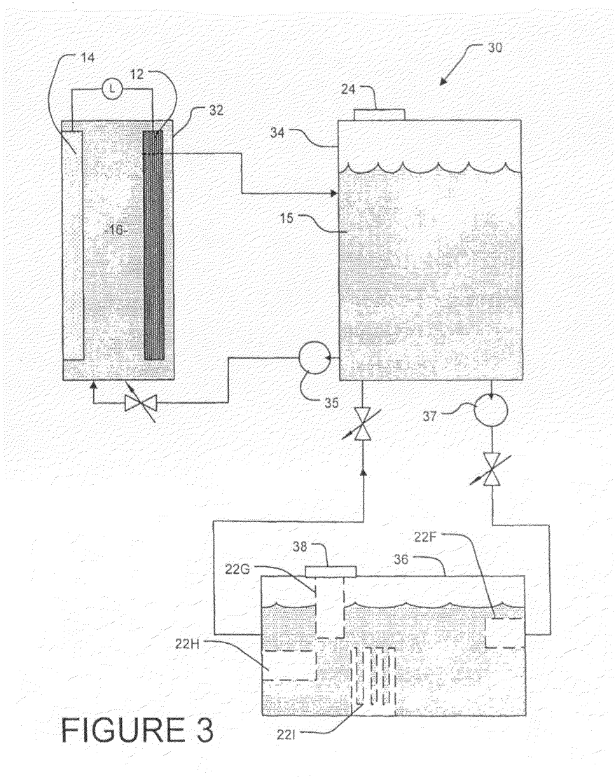

FIG. 3 shows a fuel cell system 30 which is similar to the systems described above except that one or more assemblies 22 are provided in a separate tank. In system 30, a zinc anode 12 is contained in a power module 32 which also comprises a cathode structure 14. Electrolyte 15 from a holding tank 34 is circulated through power module 32 by a pump 35. Electrolyte 15 from holding tank 34 is also circulated through a treatment tank 36 by a pump 37. In some embodiments, a single pump may provide the functions of both pumps 35 and 37.

Treatment tank 36 has one or more assemblies 22. In the illustrated embodiment, the assemblies are provided as follows:
An assembly 22F is provided at an inlet to tank 36;
An assembly 22G is supported on a removable cap 38 in a wall of tank 36;
An assembly 22H is supported on an inner wall of tank 36 outside of the direct flow of electrolyte 15 to an outlet of tank 36;
An assembly 22I has the form of a plurality of fins projecting from an inner wall of tank 36.

### Zinc Recovery

Zinc may be recovered from used assemblies 22 in various ways. For example, zincate ions may be allowed to enter a solution from which zincate may be recovered by electroplating. The solution may comprise a potassium hydroxide solution, for example. As the soluble zincate concentration drops below saturation during zinc plating, the calcium zincate in assemblies 22 will release zincate ions and convert back to calcium hydroxide. Alternative options to recover zincate from calcium zincate include concentrating the electrolyte above the calcium zincate stability limit, as described in R. A. Sharma, Physico-Chemical Properties of Calcium Zincate, Journal of the Electrochemical Society, Vol. 133, No. 11, p. 2215, November 1986.

In some embodiments, assemblies 22 may be regenerated in situ. For example, in system 30 as shown in FIG. 3, treatment tank 36 may be isolated from the rest of the system with suitable valves, and the assemblies 22 associated with treatment tank 36 may be regenerated by plating zinc from the electrolyte 15 contained within treatment tank 38 onto an electrode (not shown) in treatment tank 38 or in another vessel into which electrolyte from treatment tank 38 is circulated. In other embodiments, assemblies 22 may be taken to a recycling center for regeneration. In such cases, the zincate-trapping material within assemblies 22 could be removed and replaced with fresh material. The removed material may then be processed to extract zinc and the original zincate-trapping material in a form suitable for reuse.

The chemical reactions that occur during the operation of a fuel cell can result in changes in the concentration of hydroxyl ions in electrolyte 15. For example, while calcium zincate formation tends to concentrate electrolyte 15, zinc dissolution tends to dilute electrolyte 15. If necessary or desired, an active system for managing electrolyte concentration by adding water and/or sodium or potassium hydroxide may be provided.

In some embodiments, calcium hydroxide in assemblies 22 removes both zincate ions and dissolved carbon dioxide in the form of carbonate ions from electrolyte 15. It is usually preferable to remove carbon dioxide from incoming air before it comes in contact with electrolyte.

Some embodiments provide a means for signaling to a user, such as a maintenance person, when the zincate-trapping material is spent. For example, a fuel cell system as described herein may provide the following:
A sensor or sensors that monitor one or more of electrolyte conductivity, the concentration of one or all species in the electrolyte, and the loading of zincate ions in the electrolyte coupled to a circuit, controller, or the like that triggers an alarm indicating that a change in assembly 22 is required. The alarm may be triggered when the monitored values satisfy a replacement criterion. The replacement criterion may comprise, for example, zincate ion loading in the electrolyte exceeding a threshold value.
A circuit, which could optionally include a suitable data processor, that tracks the charge passed by the fuel cell (e.g., ampere-hours) since the assembly 22 containing the zincate trapping material was last serviced or replaced. This can be compared to an energy output that the assembly 22 can support, which will depend upon the capacity of provided assemblies 22 to remove zincate ions as well as the total amount of electrolyte in the system. An alarm may be triggered when the energy output crosses a threshold indicating that assemblies 22 require servicing or replacement (and/or will soon require servicing or replacement). The circuit may be manually or automatically reset when assembly or assemblies 22 are changed. Such systems may also determine and display or record a bar graph, numeric display, or other suitable manner an amount of capacity of assemblies 22 that has been consumed or is remaining.
   Systems for monitoring the condition of zinc-scavenging assemblies 22 may be integrated with or connected to an overall control system that manages the operation of a fuel cell or other system as described herein. The control system may protect the fuel cell to prevent operation outside of acceptable parameters. For example, the control system may cut off or limit current draw from the fuel cell in cases where the electrolyte quality is not sufficient for full output.

It can be appreciated that embodiments of the invention may provide various advantages over conventional zinc/air fuel cells or mechanically rechargeable batteries, such as the following:
Reduced life cycle costs;
Improved performance
Reduced turn-over of electrolyte
Easier recycling of zinc by providing assemblies that isolate and contain scavenged zinc which can be easily separated from a fuel cell system
Reduced size and weight of the systems.
   It is not mandatory that any or all of these advantages be provided in any specific embodiment of the invention.

Selected embodiments as discussed herein apply materials that can react with zincate ions in solution to extend the useful life of an electrolyte and improve the electrolyte performance characteristics. In such embodiments removing zincate ions from the electrolyte promotes a high electrolyte conductivity and low concentration of zincate ions.

Where a component (e.g., a pump, reservoir, assembly, device, conductor, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example, the following are possible:
Zincate-trapping materials other than calcium hydroxide may be provided in assemblies 22 in addition to or instead of calcium hydroxide
A zincate-trapping material may be distributed over a surface such as the inside of an electrolyte holding tank or the inside wall of a conduit for carrying electrolyte
Electrolyte 15 is not limited to being a KOH electrolyte. Electrolyte 15 could, for example, comprise NaOH or a suitable mixture of KOH, NaOH, and LiOH in addition to electrolyte additives used for various functions within the zinc/air cell, such as reducing corrosion and inhibiting zinc oxide precipitation.
Assemblies 22 may comprise multiple zincate-trapping materials.
Structures as described herein may be applied with appropriate trapping materials to ions other than zincate from electrolytes.
   It is intended that the following appended claims and claims hereafter introduced are interpreted to include all such modifications, permutations, additions and sub-combinations as are within their scope.

1. A zinc/air electrochemical system comprising:
a first zinc-containing electrode;
a second gas-diffusion electrode;
an alkaline electrolyte; and,
a zincate-trapping material in contact with the alkaline electrolyte and spaced apart from the first electrode.

2. A system according to claim 1 wherein the zincate-trapping material comprises an alkaline-earth element.

3. A system according to claim 1 wherein the zincate-trapping material comprises a calcium compound.

4. A system according to claim 1 wherein the zincate-trapping material comprises a material selected from the group consisting of calcium hydroxide, magnesium hydroxide, barium hydroxide, strontium hydroxide, and mixtures thereof.

5. A system according to claim 1 comprising a pump connected to circulate the electrolyte past the first and second electrodes.

6. A system according to claim 5 comprising a first vessel and a reservoir wherein the first and second electrodes are located in the first vessel and the pump is connected to circulate the electrolyte between the reservoir and the first vessel.

7. A system according to claim 6 wherein the zincate-trapping material is located in a fluid conduit through which the electrolyte flows when the pump is operating.

8. A system according to claim 6 wherein the zincate-trapping material is located in the reservoir.

9. A system according to claim 6 wherein the zincate-trapping material is located in the first vessel.

10.-11. (canceled)

12. A system according to claim 5 wherein the zincate-trapping material is confined within an assembly;
the assembly comprises a cartridge having an inlet, an outlet, a first passage establishing a fluid connection between the inlet and the outlet, and
the zincate-trapping material is confined in a section of the first passage between a first electrolyte-permeable barrier and a second electrolyte-permeable barrier.

13. A system according to claim 12 wherein the first barrier comprises at least one of: a mesh, an electrolyte-permeable membrane, an apertured plate, and an electrolyte-permeable wall of a sack.

14.-16. (canceled)

17. A system according to claim 8 wherein the reservoir comprises a removable cap and the zincate-trapping material is contained in an assembly attached to the removable cap.

18. A system according to claim 6 comprising a treatment tank in fluid communication with the reservoir wherein the zincate-trapping material is located in the treatment tank.

19. A system according to claim 18 comprising first and second fluid conduits connecting the reservoir to the treatment tank and a treatment circulation pump disposed to cause the electrolyte to flow from the reservoir to the treatment tank in the first conduit and to flow from the treatment tank to the reservoir in the second conduit.

20. A system according to claim 19 wherein the zincate-trapping material is provided in an assembly located at an inlet to the treatment tank from the first conduit.

21. A system according to claim 19 wherein the zincate-trapping material is provided in an assembly disposed on a removable cap in a wall of the treatment tank.

22. A system according to claim 19 wherein the zincate-trapping material is provided in an assembly supported on an inner wall of the treatment tank.

23. A system according to claim 19 wherein the zincate-trapping material is provided in an assembly comprising a plurality of fins projecting from an inner wall of the treatment tank.

24. A system according claim 1 wherein the zincate-trapping material comprises a material that is immobilized on a surface of a structure that contains the electrolyte within the system.

25. A system according to claim 1 wherein the zincate-trapping material comprises mobile particles.

26. A system according to claim 25 wherein the mobile particles are confined within an assembly comprising an electrolyte-permeable barrier.

27.-28. (canceled)

29. A system according to claim 1 comprising a reaction vessel wherein the zincate-trapping material is present as an unconsolidated powder within the reaction vessel and the system comprises an agitator operable to continuously or intermittently agitate the zincate-trapping material.

30. A system according to claim 1 comprising a reaction vessel wherein the zincate-trapping material is present as unconsolidated particles in the reaction vessel and the reaction vessel comprises electrolyte passages configured to provide an upflow of the electrolyte through the particles.

31.-35. (canceled)

36. A system according to claim 1 wherein the zincate-trapping material comprises a powder that is immobilized on beads.

37. A system according to claim 36 wherein the beads comprise polypropylene beads or polyethylene beads.

38.-39. (canceled)

40. A system according to claim 1 wherein the zincate-trapping material comprises a powder that is immobilized on a foam support.

41. A system according to claim 40 wherein the foam support comprises a polypropylene foam or a polyethylene foam.

42.-43. (canceled)

44. A system according to claim 1 wherein the zincate-trapping material comprises a powder that is immobilized on a porous support.

45.-50. (canceled)

51. A system according to claim 1 wherein the zincate-trapping material is present as a powder that is immobilized on one or both sides of an alkaline-resistant sheet.

52. A system according to claim 51 wherein the alkaline-resistant sheet comprises a nickel foil, polypropylene sheet, alkaline-stable cermet sheet, or FR-4 board.

53. (canceled)

54. A system according to claim 1 comprising a monitoring system, the monitoring system configured to generate an estimate of the remaining capacity of the zincate-trapping material and comprising an indicator responsive to the estimate that indicates when the zincate-trapping material should be replaced wherein the monitoring system comprises a current sensor and the monitoring system is configured to generate the estimate based at least in part on an integration of the electrical current measured by the current sensor.

55.-97. (canceled)
